(19) United States
(12) Patent Application Publication
(10) Pub. No.: US 2016/0299286 A1
(43) Pub. Date: Oct. 13, 2016

(54) BACKLIGHT UNIT AND DISPLAY DEVICE INCLUDING THE SAME

(71) Applicant: Samsung Display Co., Ltd., Yongin-si (KR)

(72) Inventors: Kwangwook CHOI, Osan-si (KR); Junwoo YOU, Seongnam-si (KR)

(21) Appl. No.: 14/923,622

(22) Filed: Oct. 27, 2015

(30) Foreign Application Priority Data
Apr. 10, 2015 (KR) 10-2015-0050896

(51) Int. Cl. F21V 8/00

(52) U.S. Cl. CPC G02B 6/0091; G02B 6/0068

(57) ABSTRACT

A backlight unit includes: a lower case including a bottom portion and a lateral portion which extends from an edge of the bottom portion; a light guide plate accommodated in the lower case; a circuit board between the lateral portion of the lower case and a light incident side of the light guide plate; a light-incident portion support at an end portion of the circuit board between the lateral portion of the lower case and the light incident side of the light guide plate, the light-incident portion support coupled to the lower case; light sources on the circuit board; a first magnetic member between the light sources which are on the circuit board; and a second magnetic member on the light incident side of the light guide plate, a polarity of the second magnetic member being opposite to a polarity of the first magnetic member.

This application claims priority to Korean Patent Application No. 10-2015-0050896, filed on Apr. 10, 2015, and all the benefits accruing therefrom under 35 U.S.C. §119, the disclosure of which is incorporated herein in its entirety by reference.

### BACKGROUND

1. Field

The invention relates to a backlight unit in which the position of a light guide plate is fixed to reduce or effectively prevent movement thereof and a display device including the backlight unit.

2. Description of the Related Art

Display devices are classified into various types including a liquid crystal display (“LCD”) device, an organic light emitting diode (“OLED”) display device, a plasma display panel (“PDP”) device, an electrophoretic display (“EPD”) device, and the like, based on a light emitting scheme thereof.

In particular, the LCD device may include a backlight unit for light generation and emission. The backlight unit may be disposed at a lower portion of the LCD device, and based on the position of a light source, may be classified into: a direct type backlight unit, an edge type backlight unit and a corner type backlight unit.

A light source within the backlight unit may generate heat while emitting light. The heat generated by the light source may be transmitted to a light guide plate also within the backlight unit, and thereby the light guide plate may be damaged such as by melting. Accordingly, maintaining a uniform interval between the light source and the light guide plate within the backlight unit is critical so as to reduce or effectively prevent damage to the light guide plate from the light source heat.

### SUMMARY

One or more exemplary embodiments of the invention are directed to a backlight unit in which the position of a light guide plate is fixed to restrict movement of the light guide plate within the backlight unit, so as to maintain an constant interval between a light source and the light guide plate within the backlight unit, and to a display device including the backlight unit.

According to an exemplary embodiment of the invention, a backlight unit includes: a lower case including a bottom portion and a lateral portion which extends from an edge of the bottom portion; a light guide plate accommodated in the lower case; a circuit board between the lateral portion of the lower case and a light incident side of the light guide plate; a light-incident portion support at an end portion of the circuit board between the lateral portion of the lower case and the light incident side of the light guide plate, the light-incident portion support coupled to the lower case; light sources on the circuit board; a first magnetic member between the light sources which are on the circuit board; and a second magnetic member on the light incident side of the light guide plate, a polarity of the second magnetic member being opposite to a polarity of the first magnetic member.

The first magnetic member between the light sources on the circuit board may be disposed to oppose the second magnetic member.

The first magnetic member which opposes the second magnetic member may be disposed on the circuit board.

One of the first magnetic member and the second magnetic member may include a metal material containing iron (Fe).

The light sources and the first magnetic member may be arranged in a line along a length of the circuit board.

The first magnetic member may be provided in plural. The light sources and the first magnetic members may be alternately disposed along a length of the circuit board.

Among the plural first magnetic members, a polarity of one of the first magnetic members may be opposite to a polarity of an adjacent first magnetic member.

In a top plan view, the light-incident portion support may define a first portion thereof and a second portion thereof which extends from the first portion thereof. A length of the first portion may be substantially parallel to the light incident side of the light guide plate and the second portion may be substantially perpendicular to the light incident side of the light guide plate.

The light-incident portion support may further include a stopper protruding from the first portion thereof toward the light guide plate.

The stopper may be a third magnetic member having magnetism.

The backlight unit may further include a fourth magnetic member on the light incident side of the light guide plate. The fourth magnetic member may oppose the third magnetic member protruding from the first portion thereof toward the light guide plate.

A polarity of the third magnetic member may be opposite to a polarity of the fourth magnetic member.

One of the third magnetic member and the fourth magnetic member may include a metal material containing iron (Fe).

The backlight unit may selectively include only one of the first magnetic member and the third magnetic member.

The backlight unit may further include a light-incident opposing portion support spaced apart from the light-incident portion support with the light guide plate interposed therebetween.

The light-incident opposing portion support may include an elastic material.

According to another exemplary embodiment of the invention, a display device includes: an upper case; a display panel below the upper case; an optical sheet below the display panel; a middle case on which the display panel and the optical sheet are mounted; and a backlight unit which provides light to the display panel. The backlight unit may include: a lower case including a bottom portion and a lateral portion which extends from an edge of the bottom portion, the lower case coupled to the middle case; a light guide plate accommodated in the lower case; a circuit board between the lateral portion of the lower case and a light incident side of the light guide plate; a light-incident portion support at an end portion of the circuit board between the lateral portion of the lower case and the light incident side of the light guide plate, the light-incident portion support coupled to the lower case; light sources on the circuit board; a first magnetic member between the light sources which are on the circuit board; and a second magnetic member on the light incident side of the light guide plate, a polarity of the second magnetic member being opposite to a polarity of the first magnetic member.

According to one or more exemplary embodiments of the invention, a light source and a first magnetic member are disposed on a circuit board, a second magnetic member opposing the first magnetic member is disposed on a light guide plate which faces the circuit board, and light-incident portion supports are disposed at opposing ends of the circuit board, such that an interval between the light guide plate and the light source may be maintained. In this regard, a polarity of the first magnetic member may be opposite to a polarity of the second magnetic member.

With such a structure, although the light guide plate experiences expansion or deformation due to light source heat absorbed therein, the position of the light guide plate may be fixed within the display device to reduce or effectively prevent movement of the light guide plate relative to other elements of the display device. Accordingly, defects of luminance degradation and light leakage which may be caused by a difference in efficiency of light incident onto the light guide plate may be reduced.

### BRIEF DESCRIPTION OF THE DRAWINGS

The above and other features of the invention will be more clearly understood from the following detailed description taken in conjunction with the accompanying drawings, in which:

FIG. 1 is an exploded perspective view illustrating an exemplary embodiment of a display device according to the invention;

FIG. 2 is a view describing an exemplary embodiment of a first magnetic member positioned relative to a second magnetic member of FIG. 1;

FIG. 3 is a top plan view illustrating an exemplary embodiment of a backlight unit according to the invention; and

FIG. 4 is an enlarged view illustrating portion A of FIG. 3.

### DETAILED DESCRIPTION

Hereinafter, exemplary embodiments of the invention of invention will be described in more detail with reference to the accompanying drawings. The invention may, however, be embodied in many different forms and should not be construed as being limited to the exemplary embodiments set forth herein.

In the drawings, certain elements or shapes may be simplified or exaggerated to better illustrate the invention, and other elements present in an actual product may also be omitted. Thus, the drawings are intended to facilitate the understanding of the invention. Like reference numerals refer to like elements throughout the specification.

Throughout the specification, when an element is referred to as being “connected” to another element, the element is physically “connected” to the other element or “electrically connected” to the other element, without an intervening element interposed therebetween or with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise without departing from the teachings herein.

In addition, when a layer or element is referred to as being “on” another layer or element, the layer or element may be directly on the other layer or element without an intervening layer or element interposed therebetween or one or more intervening layers or elements may be interposed therebetween.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

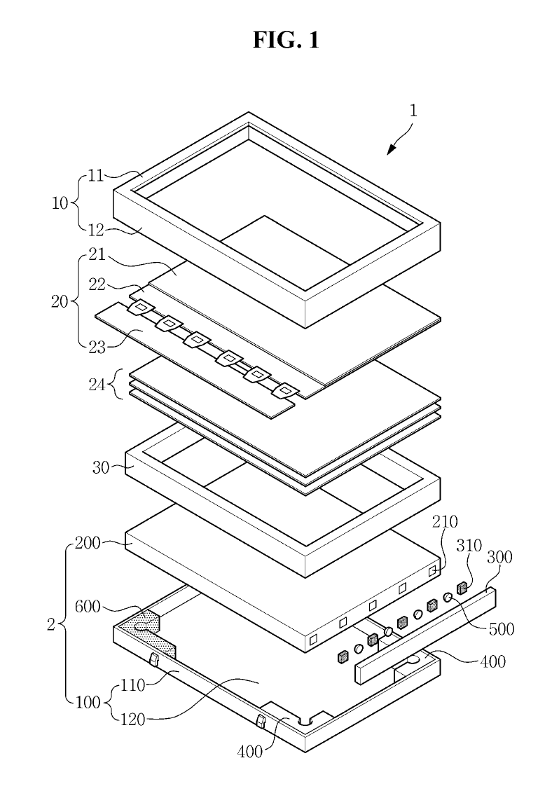

FIG. 1 is an exploded perspective view illustrating an exemplary embodiment of a display device 1 according to the invention.

Referring to FIG. 1, the display device 1 includes an upper case 10, a display panel 20, an optical sheet 24, a middle case 30, a lower case 100, a light guide plate 200, a circuit board 300, a light-incident portion support 400, a light source 500, a first magnetic member 310 and a second magnetic member 210.

Further, a backlight unit 2 includes the lower case 100, the light guide plate 200, the circuit board 300, the light-incident portion support 400, the light source 500 the first magnetic member 310, and the second magnetic member 210, among the components of the display device 1.

The upper case 10 may have defined therein, an opening window to expose an active (display) area of the display panel 20 outwards at a viewing side of the display device 1. The upper case 10 may be disposed to cover an edge portion of an upper surface and to cover a lateral surface of the display panel 20.

The upper case 10 may define a bezel unit 11 covering the edge portion of the upper surface of the display panel 20, and a lateral wall portion 12 which is bent downwards from the bezel unit 11 to cover the lateral surface of the display panel 20. The edge portion of the upper surface of the display panel 20 may define a planar area of a bezel of the display device 1 in the top plan view.

The bezel unit 11 may fix the edge portion of the upper surface of the display panel 20 relative to the backlight unit 2 to reduce or effectively prevent detachment of the display panel 20 from the backlight unit 2. The lateral wall portion 12 may be fixed to the middle case 30 or the lower case 100. The lateral wall portion 12 may be fixed to the middle case 30 or the lower case 100 through hook coupling and/or screw coupling, but the invention is not limited thereto.

The upper case 10 may include a rigid metal material, such as stainless steel, or may include a material having relatively good heat dissipation properties, such as aluminum (Al) or an aluminum (Al) alloy.

The display panel 20 may be provided in a quadrangular plate form shape and displays an image using light. The display panel 20 may include a first display substrate 22, a second display substrate 21 opposing the first display substrate 22, and a liquid crystal layer (not illustrated) disposed between the first display substrate 22 and the second display substrate 21.

The first display substrate 22 may include a plurality of pixel electrodes arranged in a matrix form on a first base substrate, a plurality of thin film transistors (“TFT”) which respectively applies a driving voltage to the plurality of pixel electrodes on the first base substrate, and various signal wirings through which signals for driving the pixel electrodes and the TFT are transmitted on the first base substrate.

The second display substrate 21 may be disposed to oppose the first display substrate 21, and may include a common electrode and a color filter on a second base substrate. The common electrode may include a transparent conductive material. The color filter may include red, green and blue filters, by way of example, but the invention is not limited thereto.

The liquid crystal layer (not illustrated) may be interposed between the first and second display substrates 22 and 21. Orientations of liquid crystal molecules of the liquid crystal layer may be rearranged by an electric field formed between the pixel electrode and the common electrode. The rearranged liquid crystal layer may adjust a level of transmittance of light emitted from the backlight unit 2, the light having the adjusted level of transmittance may pass through the color filter, and thus an image may be displayed outwards to the viewing side of the display device 1.

Although not illustrated, a lower polarizing plate and an upper polarizing plate may further be disposed on a lower surface of the first display substrate 22 and an upper surface of the second display substrate 21, respectively. The upper polarizing plate and the lower polarizing plate may each have an overall planar area corresponding to an overall planar area of the display panel 20. The upper polarizing plate may pass therethrough a predetermined component of polarized light from among externally supplied light, and may absorb or block the remainder of the externally supplied light. The lower polarizing plate may pass therethrough a predetermined component of polarized light from among the light emitted from the backlight unit 2, and may absorb or block the remainder of the light emitted from the backlight unit 2.

A driving circuit board 23 may be disposed on at least one side of the display panel 20. The driving circuit board 23 may apply a driving signal to the various signal wirings disposed in the first display substrate 22. The driving circuit board 23 may include a gate driving circuit board which applies a scan signal to scan signal lines of the first display substrate 22 and a data driving circuit board which applies a data signal to data signal line of the first display substrate 22. FIG. 1 illustrates the driving circuit board 23 disposed on one side of the display panel 20, but the invention is not limited thereto.

The optical sheet 24 may be disposed below the display panel 20 in a cross-sectional thickness direction of the display device 1, and may serve to diffuse or collimate light transmitted from the light guide plate 200. The optical sheet 24 may include a diffusion sheet, a prism sheet and a protection sheet. FIG. 1 illustrates that there are individual three optical sheets 24, but the invention is not limited thereto. In some exemplary embodiments, more or less than three individual optical sheets may be provided in the optical sheet 24.

The diffusion sheet may disperse light that is incident from the light guide plate 200, to be described further below, so as to reduce or effectively prevent the light from being partially concentrated.

The prism sheet may include prisms having a triangular cross-section and having lengths extended in an extension direction to be arranged in a predetermined array at a surface thereof. The prism sheet may be disposed on the diffusion sheet and may collimate diffused light from the diffusion sheet in a direction perpendicular to the display panel 20.

The protection sheet may be disposed on the prism sheet and may serve to protect a surface of the prism sheet and diffuse light from the prism sheet to achieve uniform light distribution for the display panel 20.

The middle case 30 may have a quadrangular shape and may define at an inside thereof, an opening extending through a thickness thereof. In other words, the middle case 30 may have a quadrangular open loop (e.g., frame) shape. The middle case 30 may accommodate therein the display panel 20, the optical sheet 24 and the light guide plate 200, which is to be described below. The middle case 30 may be provided as a single unitary member as illustrated in FIG. 1, but alternatively, a plurality of separate units may be assembled to form the middle case 30, where necessary.

The lower case 100 may include a bottom portion 120 and a lateral (sidewall) portion 110 which extends towards the display panel 20 from the bottom portion 120. The bottom portion 120 may form a planar surface of the lower case 100. The lateral portion may be disposed at an (outer) edge of the bottom portion 120. In particular, the lower case 100 may define the lateral portion 110 bent in a direction, that is, an upper direction referring to FIG. 1, from the edge of the bottom portion 120. That is, the lateral portion 110 may be substantially perpendicular to the bottom portion 120. Accordingly, the lower case 100 may define an accommodation space by the bottom portion 120 and the lateral portion 110 thereof.

The lower case 100 may include a relatively rigid metal material, such as stainless steel, or may include a material having relatively good heat dissipation properties, such as aluminum (Al) or an aluminum (Al) alloy. The lower case 100 may maintain a configuration of the display device 1 in the top plan view, and may protect various components of the display device 1 accommodated therein.

The light guide plate 200 may be accommodated in the lower case 100 which is disposed under the light guide plate 200, and may be accommodated in and supported by the middle case 30 which is disposed above the light guide plate 200. In addition, a side of the light guide plate 200 may be disposed to oppose the light source 500 to be described below. The light guide plate 200 may be provided in a quadrangular plate shape, but is not limited thereto. In some exemplary embodiments, the light guide plate 200 may have various configurations for which a predetermined groove and/or a protrusion is defined therefor based on the position of the light source 500. The light guide plate 200 may uniformly provide light provided from the light source 500 to the display panel 20.

Herein, the light guide plate 200 is described as a plate for ease of description, but the invention is not limited thereto. The light guide plate 200 may be provided in a sheet or film form, having a relatively small thickness as compared to a planar dimension thereof, to achieve a reduced thickness of the display device 1. That is, in exemplary embodiments, the light guide plate 200 may include not only a plate shape but also a film shape for guiding light.

The light guide plate 200 may define a light emitting surface thereof facing the display panel 20 and through which light is emitted to the display panel 20, a rear surface thereof opposite to the light emitting surface, and side surfaces thereof connecting the light emitting surface and the rear surface to each other. One or more of the side surfaces may be a light incident surface of the light guide plate 200.

The light guide plate 200 may include or be formed of a light-transmissive material such as, for example, an acrylic resin, such as polymethylmethacrylate (“PMMA”) or polycarbonate (“PC”) so as to guide light efficiently.

Although not illustrated, a reflection sheet may be disposed between the light guide plate 200 and the lower case 100. The reflection sheet may reflect light emitted downwards from the light guide plate 200 to be re-directed toward the display panel 20, thereby improving light efficiency.

The circuit board 300 may be provided in a quadrangular plate form, and may be disposed between the lateral portion 110 of the lower case 100 and a side of the light guide plate 200. Accordingly, the circuit board 300 may oppose at least a side of the light guide plate 200, such that a surface of the circuit board 300 faces a light incident surface of the light guide plate 200. The circuit board 300 may be a printed circuit board (“PCB”) or a metal PCB.

The light source 500 may be disposed on a surface of the circuit board 300. The surface at which the light source 500 is disposed faces a light incident surface of the light guide plate 200. The light source 500 may emit light toward the light guide plate 200. The light source 500 may include at least one discrete light source such as a light emitting diode (“LED”) chip (not illustrated) and a LED package (not illustrated) for accommodating the LED chip. In an exemplary embodiment, for example, the LED chip (not illustrated) may be a gallium nitride (GaN)-based LED chip that emits blue light. In an exemplary embodiment, the light source 500 may be provided in plural on the circuit board 300.

The number of the light source 500 may vary in consideration of size and luminance uniformity of the display panel 20. A plurality of light sources 500 may be arranged in a line along a longitudinal direction (e.g., a length direction) of the circuit board 300.

Although not illustrated in FIG. 1, a heat dissipating member (not illustrated) may be disposed between the light source 500 and the lower case 100. The heat dissipating member may dissipate heat generated from the light source unit 500 outwards. When the light sources 500 are disposed on a lateral surface of the lower case 100 in a bar or line shape arrangement, a conductive material member having a bar or line shape may be disposed as the heat dissipating member. Accordingly, the heat dissipating member may have various shapes based on the shape and/or arrangement of the light source 500.

The first magnetic member 310 may be a magnetic body having magnetism, and may be disposed on the circuit board 300. In particular, the first magnetic member 310 may be disposed between adjacent light sources 500 among a plurality of light sources 500 disposed on the circuit board 300. The first magnetic member 310 may be provided in plural, and the plural first magnetic members 310 may be arranged in a line along the longitudinal direction of the circuit board 300. The first magnetic member 310 may attract the second magnetic member 210, which is to be described below, with an attractive force mediated by a magnetic field. Accordingly, the first magnetic member 310 may fix the position of the second magnetic member 210.

As an example, the first magnetic member 310 may be provided on and fixed to the circuit board 300 through a surface mounting technology (“SMT”) process. As another example, a hole may be defined in the circuit board 300 through a process such as using a drill, and subsequently, the first magnetic member 310 may be inserted into the hole to thereby be fixed to the circuit board 300. As yet another example, the first magnetic member 310 may be attached to the circuit board 300 such as by using a bond or an adhesive tape.

The second magnetic member 210 may be disposed at a side of the light guide plate 200, and may be fixed to the light guide plate 200. The second magnetic member 210 may be disposed at a side surface of the light guide plate 200, such as at a light incident side surface of the light guide plate 200. In addition, when the light guide plate 200 is disposed to face the circuit board 300, the second magnetic member 210 may be disposed to oppose the first magnetic member 310. Accordingly, where plural first magnetic members 310 are disposed in a line, plural second magnetic members 210 may be disposed in a line, opposing the first magnetic members 310.

As an example, the second magnetic member 210 may be provided and fixed to the light guide plate 200 such as through insert injection (e.g., double insert injection). As another example, a groove may be defined at a side of the light guide plate 200 such as through a process using a drill, and subsequently, the second magnetic member 210 may be inserted into the hole to thereby be fixed to the light guide plate 200. As yet another example, the second magnetic member 210 may be attached to the light guide plate 200 such as by using a bond or an adhesive tape.

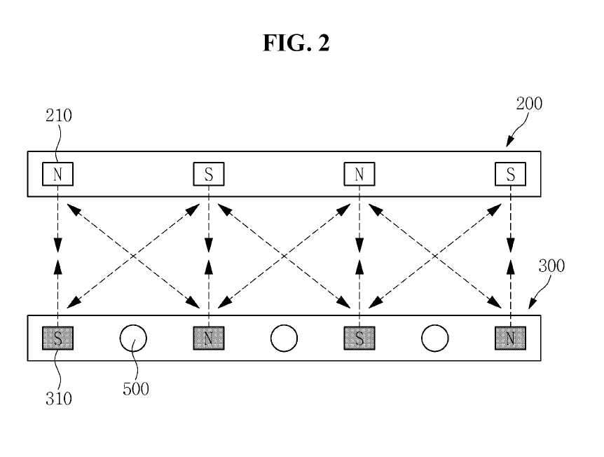

In particular, the second magnetic member 210 may have an opposing polarity against that of the first magnetic member 310, which will be described hereinbelow with reference to FIG. 2. FIG. 2 is a view describing positions of the first magnetic member 310 relative to the second magnetic member 210 of FIG. 1.

As an example, where the first magnetic member 310 has a north pole (“N”), the second magnetic member 210 opposing the first magnetic member 310 may have a south pole (“S”). Alternatively, the poles of the first magnetic member 310 and the second magnetic member 210 may be set to be opposite therefrom.

When the first magnetic member 310 and the second magnetic member 210 are disposed to respectively have polarities opposing each other, the first magnetic member 310 and the second magnetic member 210 may impart magnetic forces thereon to attract each other. Referring to FIG. 2, arrows are pointed towards each other to show attraction between magnetic members. Accordingly, since positions of magnetic members are fixed, the position of the light guide plate 200 including the second magnetic member 210 may be fixed relative to the circuit board 300 including the first magnetic member 310.

In addition, among the first magnetic members 310 arranged along a length of the circuit board 300, one of the first magnetic members 310 that are arranged in a line on the circuit board 300 may have an opposing polarity against that of another of the first magnetic members 310 that is disposed adjacent thereto. That is, the polarities of the first magnetic members 310 arranged along the length of the circuit board 300 may alternate. In this regard, among the second magnetic members 210 arranged along a length of the side surface of the light guide plate 200, a second magnetic member 210 may be disposed to have an opposing polarity against that of a corresponding (e.g., opposing) first magnetic member 310. That is, the polarities of the second magnetic members 210 arranged along a length of the light incident surface of the light guide plate 200 may alternate. In other words, a second magnetic member 210 may attract an opposing first magnetic member 310 that is disposed to oppose the second magnetic member 210, but may repel a non-opposing first magnetic member 310 that is disposed adjacent to the opposing first magnetic member 310. Referring again to FIG. 2, arrow heads are pointed away from each other to show repulsion between magnetic members.

Accordingly, the second magnetic member 210 of the light guide plate 200 which is attracted to an opposing first magnetic member 310 of the circuit board 300 but is repelled by a non-opposing first magnetic member 310 may reduce or effectively prevent movement of the light guide plate 200 in a longitudinal direction of the circuit board 300 and in a direction in which the light source 500 is spaced apart from the light guide plate 200.

One of the first magnetic member 310 and the second magnetic member 210, which are disposed to oppose each other, may include a metal material containing iron (Fe). In an exemplary embodiment, for example, in a case where the first magnetic member 310 includes a metal material, since the second magnetic member 210 disposed to oppose the first magnetic member 310 has magnetism, an attraction force may be induced therebetween.

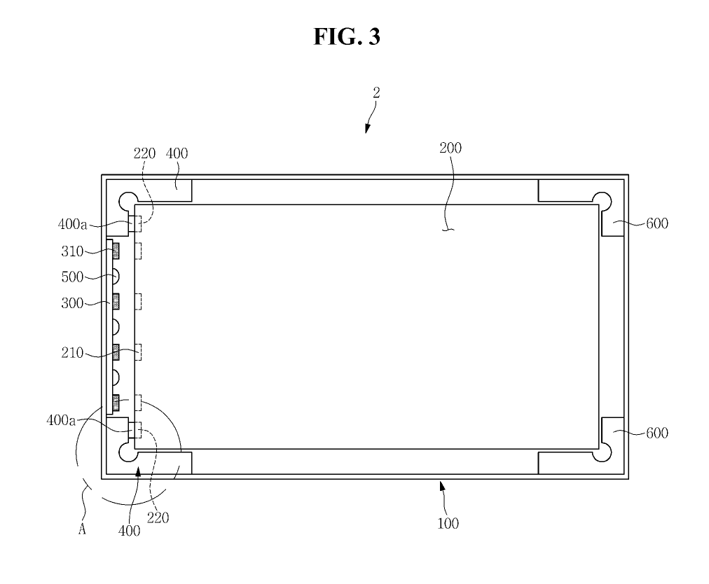

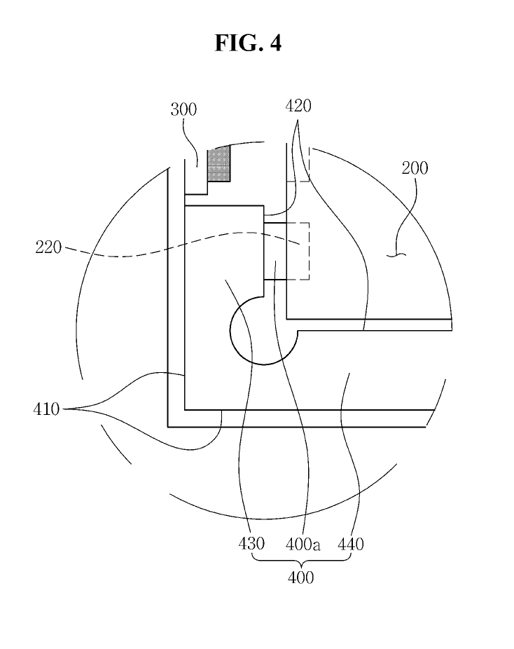

FIG. 3 is a top plan view illustrating the backlight unit 2 according to the invention; and FIG. 4 is an enlarged view illustrating portion A of FIG. 3.

Referring to FIGS. 3 and 4, the light-incident portion support 400 may be disposed at an end portion of the circuit board 300. The light-incident portion support 400 is disposed between the light guide plate 200 and the lower case 100. An entirety of the light-incident portion support 400 may be disposed between the light guide plate 200 and the lower case 100. Accordingly, an outer surface 410 of the light-incident portion support 400 may be coupled to the lower case 100, and an inner surface 420 thereof may be in contact with the light guide plate 200 directly or indirectly.

The light-incident portion support 400 may include a horizontal portion 430 and a vertical portion 440. The light-incident portion support 400 may define the horizontal portion 430 thereof and the vertical portion 440 thereof. A length of the horizontal portion 430 of the light-incident portion support 400 may be substantially parallel to a light incident side of the light guide plate 200, and a length of the vertical portion 440 thereof may be substantially perpendicular to the light incident side of the light guide plate 200.

The length of the horizontal portion 430 may be disposed along an axis substantially the same as an axis of the length of the circuit board 300. Accordingly, the horizontal portion 430 may oppose the light guide plate 200 in a direction in which the light guide plate 200 faces the circuit board 300. The horizontal portion 430 of the light-incident portion support 400 may maintain an interval between the light guide plate 200 and the circuit board 300. With such a structure, although experiencing expansion or deformation due to heat generated from the light source 500, a position of the light guide plate 200 may be maintained at a predetermined interval from the light source 500. Accordingly, deformation due to a relatively high temperature heat from the light source 500 such as melting of a portion of the light guide plate 200, which is adjacent to the light source 500, may be reduced or effectively prevented. The vertical portion 440 may reduce or effectively prevent movement of the light guide plate 200 in the longitudinal direction of the circuit board 300.

In addition, the light-incident portion support 400 may further include a stopper 400a. The stopper 400a may be disposed on the horizontal portion 430. In particular, the stopper 400a may protrude from a main portion of the horizontal portion 430 toward the light guide plate 200. In an exemplary embodiment of manufaturing a display device 1, the stopper 400a may be formed through insert injection (e.g., double insert injection), at the same time the light-incident portion support 400 is formed. The light-incident portion support 400 including the horizontal portion 430, the vertical portion 440 and the stopper 400a may be a single unitary member, but the invention is not limited thereto. In an exemplary embodiment, the stopper 400a may be separately provided and attached to the horizontal portion 430 such as using a bond or an adhesive tape.

The stopper 400a maintains an interval between the light guide plate 200 and the light source 500, and may be a magnetic body having magnetism. Hereinafter, in order to distinguish the stopper 400a, which is a magnetic body, from the first and second magnetic members 310 and 210, the stopper 400a may be referred to as a third magnetic member 400a.

The light guide plate 200 may include a fourth magnetic member 220 disposed to oppose the third magnetic member 400a. Herein, the third magnetic member 400a may have an opposing polarity against that of the fourth magnetic member 220. As an example, where the third magnetic member 400a has a north

(“N”) pole, the fourth magnetic member 220 may have a south (“S”) pole. When the third magnetic member 400a and the fourth magnetic member 220 respectively have polarities opposing one another, the third magnetic member 400a and the fourth magnetic member 220 may attract each other, such that the position of the light guide plate 200 may be further fixed relative to the circuit board 300 and the light source 500.

One of the third magnetic member 400a and the fourth magnetic member 220 may include a metal material containing iron (Fe). In an exemplary embodiment, for example, where the third magnetic member 400a includes a metal material, by virtue of the fourth magnetic member 220, an attraction force may be induced therebetween.

Hereinabove, the backlight unit 2 and the display device 1 including the backlight unit 2 may be illustrated as including both the first and third magnetic members 310 and 400a, and the second and fourth magnetic members 210 and 220 which are respectively disposed to oppose the first and third magnetic members 310 and 400a. However, the invention is not limited thereto.

That is, according to another exemplary embodiment, a display device 1 and a backlight unit 2 may selectively include only one of a first magnetic member 310 and a third magnetic member 400a. Where the backlight unit 2 and the display device 1 including the backlight unit 2 includes only one of the first magnetic member 310 and the third magnetic member 400a, only one of a second magnetic member 210 which opposes the first magnetic member 310, and a fourth magnetic member 220 which opposes the third magnetic member 400a, may be selectively provided.

Referring to FIGS. 1 and 3, the backlight unit 2 and the display device 1 including the backlight unit 2 may further include a light-incident opposing portion support 600.

Referring to FIGS. 3 and 4, the light-incident opposing portion support 600 may be spaced apart from the light-incident portion support 400 with the light guide plate 200 interposed therebetween. The light-incident opposing portion support 600 may have a form substantially the same as that of the light-incident portion support 400. However, the invention is not limited thereto, and the light-incident opposing portion support 600 may have various forms as necessary.

In addition, the light-incident opposing portion support 600 may further support the light guide plate 200. Similar to the light-incident portion support 400, portions of the light-incident opposing portion support 600 are respectively disposed parallel and perpendicular to the light incident side of the light guide plate 200. Accordingly, although the light guide plate 200 experiences expansion or deformation due to heat absorbed therein, the light-incident opposing portion support 600 may reduce or effectively prevent movement of the light guide plate 200 in upwards, downwards, leftwards or rightwards directions in the top plan view of the backlight unit 2.

The light-incident opposing portion support 600 may include a relatively soft material, compared to that of the light-incident portion support 400, so as to absorb pressure caused by displacement or expansion of the light guide plate 200. In other words, the light-incident opposing portion support 600 may include an elastic material that may absorb pressure.

From the foregoing, it will be appreciated that various exemplary embodiments in accordance with the present disclosure have been described herein for purposes of illustration, and that various modifications may be made without departing from the scope and spirit of the invention. Accordingly, the various embodiments disclosed herein are not intended to be limiting of the true scope and spirit of the invention.

What is claimed is:

1. A backlight unit comprising:
a lower case comprising a bottom portion and a lateral portion which extends from an edge of the bottom portion;
a light guide plate accommodated in the lower case;
a circuit board between the lateral portion of the lower case and a light incident side of the light guide plate;
a light-incident portion support at an end portion of the circuit board, the light-incident portion support coupled to the lower case;
light sources on the circuit board;
a first magnetic member between the light sources; and
a second magnetic member on the light incident side of the light guide plate, wherein a polarity of the second magnetic member is opposite to a polarity of the first magnetic member.

2. The backlight unit of claim 1, wherein the first magnetic member between the light sources on the circuit board opposes the second magnetic member.

3. The backlight unit of claim 2, wherein the first magnetic member which opposes the second magnetic member is disposed on the circuit board.

4. The backlight unit of claim 3, wherein one of the first magnetic member and the second magnetic member comprises a metal material containing iron (Fe).

5. The backlight unit of claim 3, wherein the light sources and the first magnetic member are arranged in a line along a length of the circuit board.

6. The backlight unit of claim 5, wherein
the first magnetic member is provided in plural, and
the light sources and the first magnetic members are alternately disposed along the length of the circuit board.

7. The backlight unit of claim 6, wherein among the plural first magnetic members, a polarity of one of the first magnetic members is opposite to a polarity of an adjacent first magnetic member.

8. The backlight unit of claim 1, wherein in a top plan view, the light-incident portion support defines a first portion thereof and a second portion thereof which extends from the first portion thereof,
wherein
a length of the first portion is substantially parallel to the light incident side of the light guide plate, and
a length of the second portion is substantially perpendicular to the light incident side of the light guide plate.

9. The backlight unit of claim 8, wherein the light-incident portion support comprises a stopper protruding from the first portion thereof toward the light guide plate.

10. The backlight unit of claim 9, wherein the stopper is a third magnetic member having magnetism.

11. The backlight unit of claim 10, further comprising a fourth magnetic member on the light incident side of the light guide plate,
wherein the fourth magnetic member on the light incident side of the light guide plate opposes the third magnetic member protruding from the first portion thereof toward the light guide plate.

12. The backlight unit of claim 11, wherein a polarity of the third magnetic member is opposite to a polarity of the fourth magnetic member.

13. The backlight unit of claim 12, wherein one of the third magnetic member and the fourth magnetic member comprises a metal material containing iron (Fe).

14. The backlight unit of claim 10, comprising only one of the first magnetic member and the third magnetic member.

15. The backlight unit of claim 1, further comprising a light-incident opposing portion support spaced apart from the light-incident portion support with the light guide plate interposed therebetween.

16. The backlight unit of claim 15, wherein the light-incident opposing portion support comprises an elastic material.

17. A display device comprising:
an upper case;
a display panel below the upper case;
an optical sheet below the display panel;
a middle case on which the display panel and the optical sheet are disposed; and
a backlight unit which provides light to the display panel, the backlight unit comprising:
a lower case comprising a bottom portion and a lateral portion which extends from an edge of the bottom portion, the lower case coupled to the middle case;
a light guide plate accommodated in the lower case;
a circuit board between the lateral portion of the lower case and a light incident side of the light guide plate;
a light-incident portion support at an end portion of the circuit board, the light-incident portion support coupled to the lower case;
light sources on the circuit board;
a first magnetic member between the light sources; and
a second magnetic member on the light incident side of the light guide plate, wherein a polarity of the second magnetic member is opposite to a polarity of the first magnetic member.
